(19) United States
(12) Patent Application Publication
(10) Pub. No.: US 2019/0064743 A1
(43) Pub. Date: Feb. 28, 2019

(54) SYSTEM FOR INTERCHANGEABLE WATCHES

(71) Applicant: Marva Clark, Houston, TX (US)

(72) Inventor: Marva Clark, Houston, TX (US)

(21) Appl. No.: 15/690,420

(22) Filed: Aug. 30, 2017

(51) Int. Cl. G04B 37/14

(52) U.S. Cl. CPC G04B 37/1486

(57) ABSTRACT

A system for interchangeable watches that includes: at least two watch bands; and at least two watches. Preferably, the at least two watch bands include up to four watch bands and the at least two watches include four watches. Each watch includes a distinct watch face, where each watch is interchangeable with any of the four watch bands.

### BACKGROUND OF THE INVENTION

### Field of Invention

The present invention relates to a system for interchangeable watches to provide various types of styling and design.

### Description of Related Art

Watches are a form of jewelry that serve both functional and esthetic purposes. Traditionally the watch has provided a timepiece for a person to accurately keep time. Watches come in many styles that include different types of wrist bands. Further pendant watches also provided along with pocket watches in the more or less traditional modes. However the traditional wrist watch is a consistent jewelry piece that is worn by both men and women. Normally a watch had one consistent style in terms of the wrist band coupled with a watch and face of the watch. However some watches do have certain aspects of interchangeability such as the accessorizing of the face of a watch or the ability to change wrist bands for a particular watch. It is the object of the present invention to provide a complete system of interchangeable watches along with watch bands so that a user may functionally change the entire appearance of their watch as desired.

### SUMMARY OF THE INVENTION

The present invention relates to a system for interchangeable watches that includes: at least two watch bands; and at least two watches. Preferably, the at least two watch bands include up to four watch bands and the at least two watches include four watches. Each watch includes a distinct watch face, where each watch is interchangeable with any of the four watch bands.

### BRIEF DESCRIPTION OF DRAWINGS

FIG. 1A depicts a first watch in accordance with the present invention.

FIG. 1B depicts a second watch in accordance with the present invention.

FIG. 1C depicts a third watch in accordance with the present invention.

FIG. 1D depicts a fourth watch in accordance with the present invention.

### DETAILED DESCRIPTION

The present invention relates to a system of interchangeable watches that provide a user with at least two watch bands. Preferably four watch bands are provided along with a watch for each band that is distinct shape and face to provide appropriate styling to be coincided with a watch. Further, the present invention allows for these watches to be interchanged between the wrist bands as desired by the user.

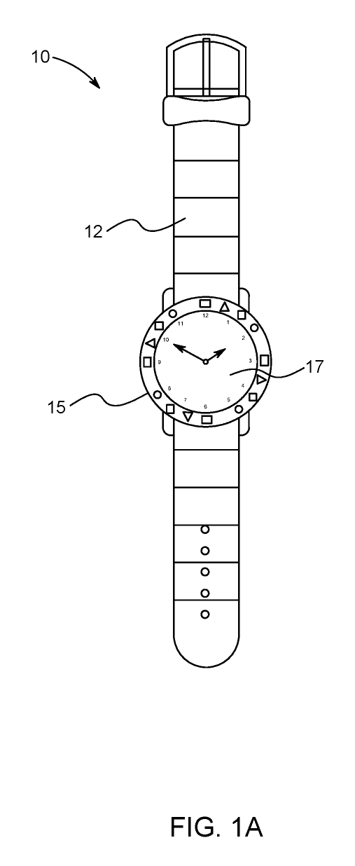

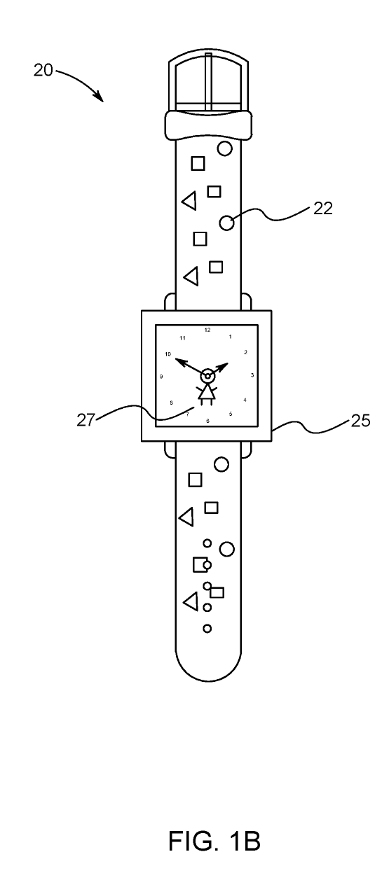

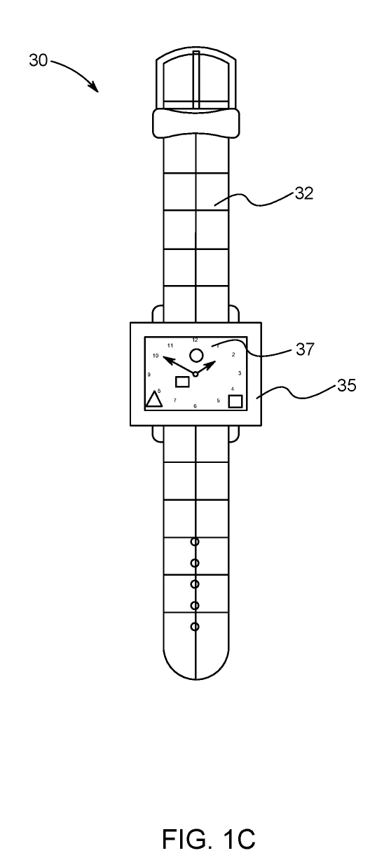

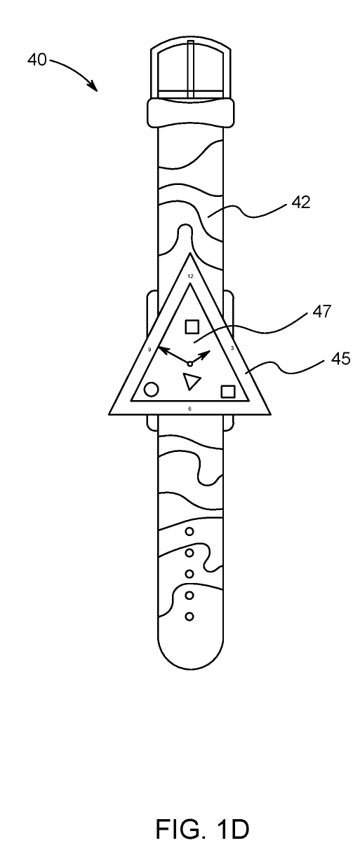

In reference to FIG. 1A, a first watch 10 is shown. The first watch 10 includes a wrist band 12 and a watch 15. This watch 15 is a circular or round shaped watch with a face 17. The face 17 includes a circular border with various shapes within the border. The band 12 includes a series of solid lines in a parallel over the length of the wrist band 12.

FIG. 1B depicts a second watch 20. The second watch 20 includes wrist band 22 and watch 25. The watch 25 is a square watch, which includes a border wherein the border is a plain border with a square face 27. This watch face 27 of watch 25 also includes a small image at the center thereof.

FIG. 1C depicts watch 30 in accordance with the present invention. The Watch 30 includes watch band 32. Watch band 32 provides a square pattern and includes a watch 35, which is rectangular in shape. This rectangular watch 35 also includes a plain border similar to watch 25 and the watch face 37 includes various geometric shapes shown on the face of the watch.

FIG. 1D depicts watch 40 that includes a watch band 42. The watch band 42 has a camouflage-type pattern with a triangular watch 45 depicted. The triangular watch 45 includes a face 47 that further has geometric shapes within the watch face 47. Uniquely the present invention allows the series of watches 15, 25, 35 and 45 to be interchanged between the four bands 12, 22, 32 and 42. Each face as shown is a unique face watch and these distinct watch faces provide distinct styles for accompanying each particular watch band. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A system for interchangeable watches comprising:
a. at least two watch bands; and
b. at least two watches, wherein each said watch includes at least one perimeter shape from the following, a round shape, a square shape, a rectangular shape or a triangular shape.

2. The system for interchangeable watches according to claim 1, where the at least two watch bands include up to four watch bands.

3. The system for interchangeable watches according to claim 2, where the at least two watches include four watches.

4. The system for interchangeable watches according to claim 3, where each watch includes a distinct watch face.

5. The system for interchangeable watches according to claim 3, where each watch is interchangeable with any of the four watch bands.

6. The system for interchangeable watches according to claim 4, further comprising a first watch, a second watch, a third watch and a fourth watch.

7. The system for interchangeable watches according to claim 6, further comprising a first watch band, a second watch band, a third watch band and a fourth watch band.
